(19) United States
(12) Patent Application Publication
(10) Pub. No.: US 2002/0076062 A1
(43) Pub. Date: Jun. 20, 2002

(54) LOW FREQUENCY SPEAKER SYSTEM

(76) Inventors: HENRY E. JUSZKIEWICZ, NASHVILLE, TN (US); ANDY J. EWEN, ESSEX (GB)

Correspondence Address: WADDEY & PATTERSON, 414 UNION STREET, SUITE 2020, BANK OF AMERICA PLAZA, NASHVILLE, TN, 37219

(21) Appl. No.: 09/383,721

(22) Filed: Aug. 26, 1999

(51) Int. Cl. H04R 1/02; H04R 1/20; H04R 9/06

(52) U.S. Cl. 381/89; 381/335; 381/345; 381/182; 381/386; 181/148; 181/198

(57) ABSTRACT

A speaker system includes two cylindrical tubular cabinets. Each cabinet has a vertical longitudinal axis and defines a cylindrical cabinet cavity therein. At least one speaker element is located in each cavity. Preferably, there are upper and lower speaker elements mounted within each cavity, and dividing the cavity into upper, middle and lower speaker cavity portions. The speaker system is particularly constructed for reproduction of the very low frequency audio data below 200 Hz, and preferably below 60 Hz, which is associated with modern high fidelity sound sources such as those using a Dolby®5.1 format.

### BACKGROUND OF THE INVENTION

1. Field of the Invention

The present invention relates generally to a high fidelity audio speaker system, and more particularly, but not by way of limitation, to such a system designed for use in the home.

2. Background of the Invention

Traditionally, when a person buys a high fidelity audio system for their home, they will buy an amplified subwoofer or low frequency speaker, separate from the remaining components.

A subwoofer is generally omni-directional in nature. That is, it is very difficult to tell what direction the sound is coming from. For this reason, conventional subwoofer systems which are utilized with high fidelity home audio include only a single subwoofer. That single subwoofer is typically a very large unattractive black box which is usually hidden behind a chair, couch or the like.

Further complicating the issue is the fact that most subwoofers include a single, very large speaker and thus, the subwoofer box is a very large relatively unattractive component which as noted is typically hidden from view. In some home environments, however, there is simply no suitable place to locate such a traditional subwoofer component out of view.

Accordingly, there is a need for improved subwoofer systems for use in the home environment which provide both improved sound quality and an aesthetically acceptable appearance, which in effect, camouflages the existence of the subwoofer and allows it to be placed in plain view.

### SUMMARY OF THE INVENTION

The present invention provides an improved low frequency speaker system.

In one embodiment, a speaker assembly includes a cylindrical tubular cabinet having a vertical longitudinal axis and having a cylindrical cabinet cavity. Upper and lower speakers are mounted within the cabinet and divide the cavity into an upper cavity portion above the upper speaker, a middle cavity portion between the speakers, and a lower cavity portion below the lower speaker. The upper speaker faces into the upper cavity portion and the lower speaker faces into the lower cavity portion. This provides a mechanical arrangement whereby the subwoofer system takes on the unique external appearance of a cylindrical cabinet, which can be appropriately finished to serve as an end table or the like. Further, by the use of two subwoofer speakers within the unit, the required diameter of each to achieve a given bass output is reduced, thus allowing the size of the cylindrical cabinetry to be maintained within acceptable dimensions.

Preferably, the speaker system will include two such speaker assemblies which provide a pair of end tables which may be placed at opposite ends of a couch or the like.

In another embodiment, the speaker system may simply include first and second vertically oriented cylindrical tubular cabinets, each of which has at least one low frequency speaker mounted therein. Each cabinet is suitably finished with a table top mounted thereon, so that the cabinets provide a pair of end tables and can serve as furniture in the home.

In still another embodiment, the present invention provides a low frequency speaker system which takes a single input signal of low frequency audio data from a source such as a Dolby® 5.1 format source, and splits that input signal and provides the split input signal to two amplifiers which are then connected to two low frequency speaker systems. Thus, the single channel of low frequency audio data is provided to two subwoofers. This is unique in that conventional systems have used only a single subwoofer speaker.

Thus, it is a general object of the present invention to provide improved low frequency speaker systems.

Another object of the present invention is to provide low frequency speaker systems having improved audio characteristics.

Still another object of the present invention is the provision of low frequency speaker systems which may be utilized in the home.

Another object of the present invention is the provision of low frequency speaker systems which have an aesthetically pleasing appearance which may be utilized as furniture.

Other and further objects, features and advantages of the present invention will be readily apparent to those skilled in the art upon a reading of the following disclosure when taken in conjunction with the accompanying drawings.

### BRIEF DESCRIPTION OF THE DRAWINGS

FIG. 1 is a perspective view of a room in a home, wherein the low frequency speaker system includes two cylindrical cabinets, each carrying a subwoofer assembly. The cabinets are shown in place at opposite ends of a couch so that they function as end tables and may function as supports for other speakers of a high fidelity audio speaker system.

FIG. 2 is a schematic illustration of the connection of the speaker system of FIG. 1 connected to a high fidelity audio source. In the embodiment of FIG. 2, each of the subwoofer assemblies is independently powered by its own self contained amplifier.

FIG. 3 is a view similar to FIG. 2, but shows an alternative embodiment wherein only one of the subwoofer assemblies is powered and that subwoofer assembly serves to also power its companion subwoofer assembly in the other cabinet.

FIG. 4 is a front elevation view of one of the subwoofer assemblies of FIG. 1.

FIG. 5 is a rear elevation view of the subwoofer assembly of FIG. 4.

FIG. 6 is an elevation sectioned view of the subwoofer assembly of FIG. 4 showing internal mounting of the speakers, baffling and tuned porting.

FIG. 7 is an elevation view of the control panel.

### DETAILED DESCRIPTION OF THE PREFERRED EMBODIMENTS

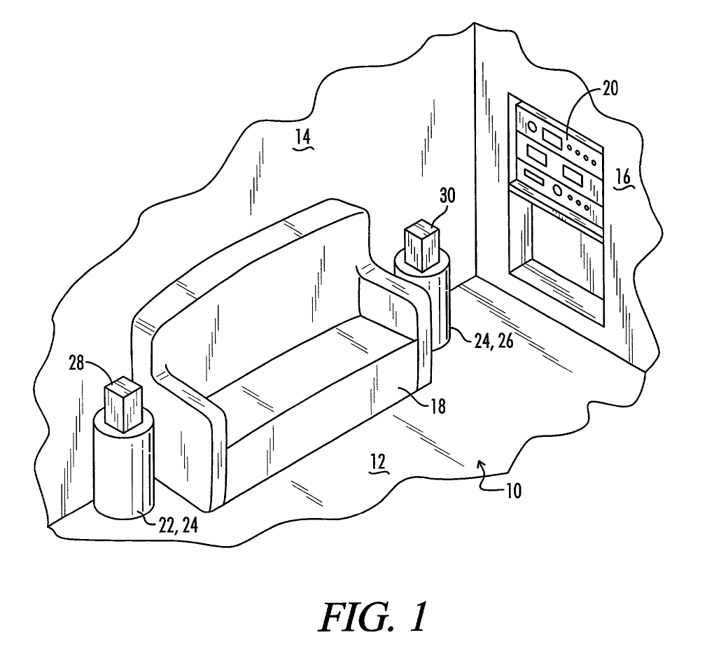

Referring now to the drawings, and particularly to FIG. 1, a room 10 is thereshown having a floor 12 and walls 14 and 16.

A couch 18 sits on the floor 12 against the wall 14. A high fidelity audio source 20 is mounted in the wall 16.

The low frequency speaker system of the present invention is shown and generally designated by the numeral 22 and includes first and second low frequency speaker assemblies 24 and 26. Conventional full range speakers 28 and 30 are shown sitting in place up on top of the speaker assemblies 24 and 26, respectively.

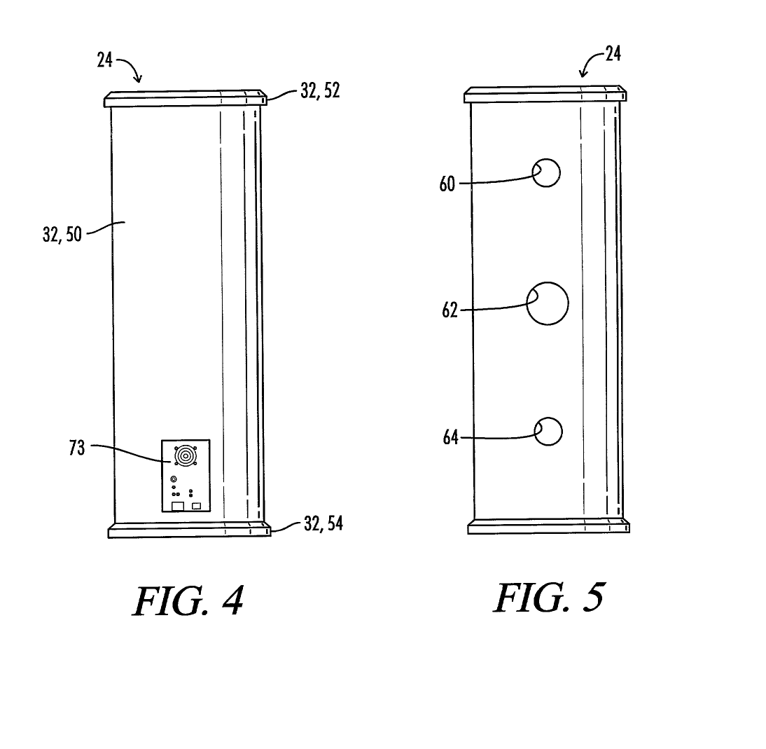

The details of the mechanical construction of one of the speaker assemblies 24 is best shown in FIGS. 4, 5 and 6.

The speaker assembly 24 includes a cylindrical tubular cabinet 32 having a vertical longitudinal axis 34 and defining a cylindrical cabinet cavity 36 therein.

Upper and lower speakers 38 and 40 are mounted within the cabinet 32 and divide the cavity 36 into upper, middle and lower cavity portions 42, 44 and 46, respectively. The upper cavity portion 42 is located above the upper speaker 42. The middle cavity portion 44 is located between the speakers. The lower cavity portion 46 is located below the lower speaker 40.

The upper speaker 38 faces into the upper cavity portion 42 so that the primary direction of acoustic energy generated by the speaker 38 is upward. The lower speaker 40 faces downward into the lower cavity portion 46 so that the acoustic energy generated by lower speaker 40 is directed primarily downward.

The cabinet 32 includes a cylindrical wall 48 which is constructed of high density cardboard and is formed from a length of high density cardboard tube. The cylindrical wall 32 may also include a wood veneer outer layer 50 for aesthetic appearance.

The cabinet 32 further includes an upper end cap 52 and a lower end cap 54 closing the upper and lower ends of the cylindrical cavity 36 defined within the cylindrical wall member 48. The upper and lower end caps 52 and 54 may be constructed from hardwood or other aesthetically pleasing material. End caps 52 and 54 are joined to cylindrical wall 48 by glue, fasteners or other suitable means. The upper end cap 52 may alternatively be referred to as a table top 52 or as a pedestal top 52, and provides an upper surface 56 upon which articles such as the other speaker components 28 and 30 may be placed.

The upper and lower speakers 38 and 40 are circular conical speakers having central axes coincident with the central vertical axis 34 of the cabinet 24. The speakers are mounted in baffles 56 and 58.

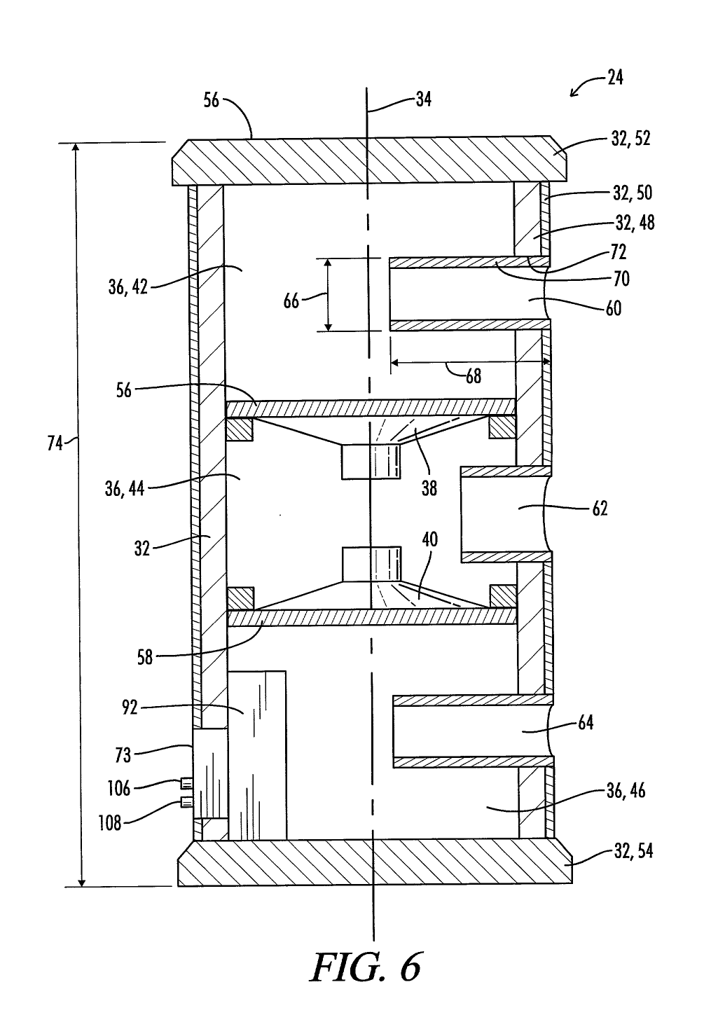

The upper, middle and lower cavity portions 42, 44 and 46 are each communicated with the exterior of the cabinet 24 by tuned ports 60, 62 and 64, respectively. Each of the tuned ports such as 60 has a diameter 66 and a length 68 which are selected to correspond to the volume of their respective cavity portions so as to provide enhancement of certain ranges of frequency of sound generated within their respective cavity portions. Each of the tuned ports such as 60 is defined by a port tube 70 mounted radially through an opening 72 in the side wall 32 of the cabinet. As illustrated in FIG. 6, the upper and lower cavity portions 42 and 46 are of substantially identical volume and are larger in volume than the middle cavity portion 44, and thus, the tuned ports 60 and 64 of the larger upper and lower cavity portions are different from the tuned port 62 of the smaller middle cavity portion 44.

FIG. 4 shows a front elevation view of the speaker assembly 24 as it would be seen by a person standing in front of the couch 18 and looking toward the couch 18 and the speaker assemblies 24 and 26. The tuned ports 60, 62 and 64 are typically oriented toward the back of the speaker assembly 24 so that they will not be seen by the viewer. FIG. 5 is a rear view of the speaker assembly 24. Of course, it will be understood that the speaker assembly 24 could actually be oriented however the user desired.

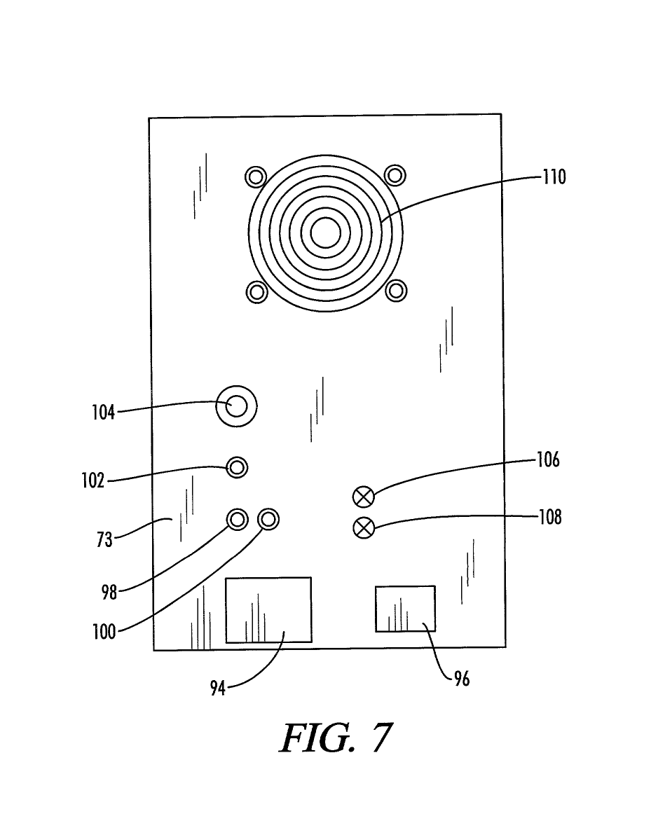

As seen in FIG. 4, and the enlarged view of FIG. 7, a control panel 73 is located on the front of the speaker assembly 24. The control panel 73 includes a number of electrical connections by means of which the speaker assembly 24 is connected to a high fidelity sound source 20.

As best seen in FIG. 7, the control panel 73 includes a fused main input 94, a power switch 96, two full range stereo inputs 98 and 100, a Dolby® 5.1 low frequency data input 102, an output 104 to be directed to the non-powered cabinet, a frequency control knob 106 and a volume control knob 108. A fan guard 110 covers a cooling fan for the amplifier 92 which is located behind the control panel 73.

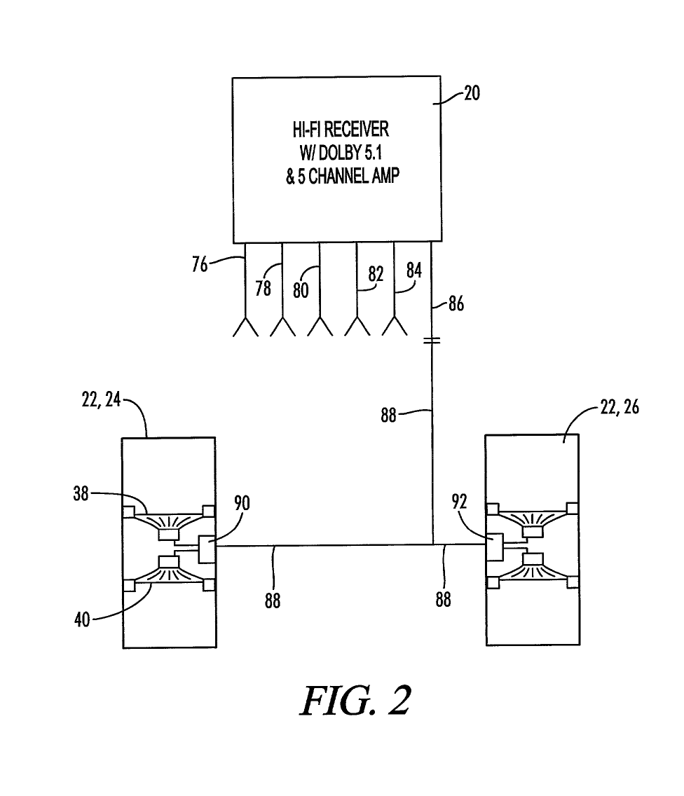

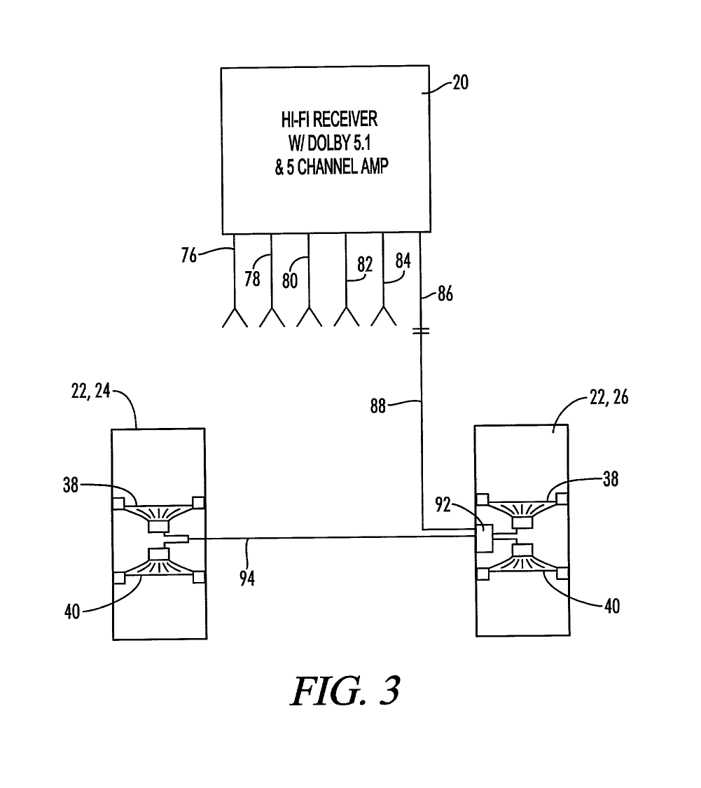

As will be further explained below with regard to the electrical schematics of FIGS. 2 and 3, one or both of the speaker assemblies 24 and 26 will include an amplifier mounted within the cylindrical cavity 36 and connected to the speakers. The amplifier will amplify the low frequency audio data being provided to the control panel 73 so as to power the large speakers of the low frequency speaker system.

In one example of the subwoofer assembly 24, the high density cardboard tube 48 will have a wall thickness of 15 mm with the veneer 50 being 1 mm thick. The external diameter of the cylindrical wall 48, 50 will be approximately 360 mm. The vertical length of the internal cavity 36 will be approximately 1,000 mm. The vertical length of the upper and lower chambers 42 and 46 will be about 400 mm each with the vertical length of the middle chamber 44 being about 200 mm.

This will provide upper and lower cavity portions 42 and 46 having volumes of approximately 31 liters each, and a middle cavity portion 44 having a volume of approximately 16 liters.

Preferably, the speaker assembly 24 has an overall height 74 in the range of 24 inches to 36 inches and preferably approximately 30 inches which places it at optimal height for the location of full range speaker systems such as 28 and 30 relative to a listener in the room 10.

Each of the cylindrical tubular cabinets preferably has an outside diameter of at least 12 inches in order to provide an end table of suitable dimensions for supporting other articles such as the full range speakers 28 and 30 illustrated in FIG. 1.

The upper and lower speakers 38 and 40 for this system may be 10 inch nominal diameter 16 ohm, 150 watt, Celestion brand speakers. The speaker baffles 56 and 58 may be 18 mm thick medium density fiberboard. The preferred speakers may be described as circular conical speakers having a nominal diameter of at least 10 inches.

The output power of a given bass speaker system is directly proportional to the cross-sectional area of the speaker element. Thus, one larger diameter speaker element may be replaced by two smaller diameter speaker elements having equivalent area.

This principle allows the cylindrical speaker cabinets of the present invention to be dimensioned in a manner most aesthetically pleasing by increasing the number of speaker elements therein.

For example, the cabinet 24 could be constructed with only a single speaker element therein, but in order to achieve the same audio output, that speaker would have to be of larger diameter than the two speaker elements illustrated. Similarly, the same audio output could be achieved with an even small diameter cylindrical cabinet by utilizing three or four speaker elements of still small diameter.

The tubes 70 defining upper and lower tuned ports 60 and 64 have an inside diameter 66 of 65 mm with a port length 68 of 176 mm. The tube of middle tuned port 62 has an inside diameter of 100 mm with a port length of 71 mm.

The upper and lower end caps 52 and 54 are each formed from 35 mm thick hardwood.

It will be understood that the dimensions just given are only an example and that this construction may be scaled up or down as desired.

The construction of the cabinets from circular tubular material provides a structurally superior cabinet which is much stronger than would be a conventional rectangular cabinet. Furthermore, the construction of the cabinet out of cylindrical tubing is particularly cost effective. The use of the high density cardboard tube provides an acoustically superior cabinet while at the same time being relatively lightweight and economical.

Turning now to FIG. 2, the manner of connection of the speaker assemblies 24 and 26 to the high fidelity sound source 20 is thereshown.

Although the speaker system 22 may be utilized with any conventional sound source 20, the speaker system 22 is particularly well adapted for emphasis of extremely high quality, extremely low frequency audio data, such as that provided in a currently available format known as Dolby® 5.1.

Over the years various formats of multiple channel audio have been developed to provide ever increasing realism in sound reproduction.

The earliest systems were monophonic having only a single channel of sound. The next development was stereophonic systems having two channels.

Then various surround sound systems, such as quadraphonic systems having four channels were developed. One of the most recently developed multi-channel sound formats is that often referred to as Dolby® AC-3 or as Dolby® 5.1, which terms both refer to the same system. The Dolby® 5.1 system delivers six completely separate channels of sound. It includes left, center and right front channels for the front of the room. It includes left and right rear channels. It includes a sixth channel which has low frequency audio data.

The Dolby® 5.1 system was originally developed to provide high quality sound in movie theaters or the like. It has more recently become available in the home from several sources.

Digital video discs, commonly to referred to DVD's, now include a Dolby® 5.1 soundtrack. Currently, probably 30% to 40% of the personal computers which are being sold include DVD players and provide a means for decoding the Dolby® 5.1 signal. Another currently available source for the Dolby® 5.1 signal in the home environment is a hi-fi receiver such as 20 for home audio system. Most hi-fi receivers being sold today include a Dolby® 5.1 decoding circuit.

When using a hi-fi receiver 20 having a Dolby® 5.1 decoding circuit, the receiver 20 itself includes five channels of amplification and provides five amplified outputs 76, 78, 80, 82 and 84. Those five amplified outputs are for the left, center and right front full range speakers and for the left and right rear full range speakers. For example, when utilizing an arrangement like that illustrated in FIG. 1, the two fill range speakers 28 and 30 sitting on top of the speaker assemblies 24 and 26 would likely be the left and right rear speakers of full range audio data utilizing two of the full range output signals 76-84. The other three full range outputs would go to the left, center and right front speakers (not shown) which would be located elsewhere in the room 10.

A sixth output 86 provides low frequency audio data intended for a subwoofer system. The sixth outlet 86 is typically unamplified, because as previously noted, conventionally available subwoofer systems are self powered, i.e. that is, they include their own amplifier.

The present invention provides suitable electrical conductors 88 which convey this low frequency audio data signal to the speakers assemblies 24 and 26 of the speaker system 22.

In the embodiment illustrated in FIG. 2, each of the speaker assemblies 24 and 26 includes its own self-contained amplifier 90 and 92, respectively, for powering the speakers of its respective cabinet.

The electrical conductor 88 may be described as an input signal conductor for carrying an input signal of low frequency audio data from output 86, and for splitting that input signal and providing the split input signal to both the first and second amplifiers 90 and 92 of the speaker assemblies 24 and 26, respectively. In the embodiment illustrated herein, the first and second amplifiers are located in separate remote speaker cabinets. This aspect of the invention involving the splitting of a low frequency data signal and directing the split signal to two amplifiers for two low frequency speakers can also be utilized with two amplifiers and two speakers located in a single cabinet. Such a system is shown in U.S. patent application Ser. No. ______, of Juszkiewicz et al., entitled “Audio Speaker System for Personal Computer”, the details of which are incorporated herein by reference.

In the embodiment of FIG. 3, only the right hand speaker assembly 26 includes an amplifier 92, and the left hand speaker assembly 24 is non-amplified. The amplifier 92 of right hand speaker assembly 22 is connected by an auxiliary electrical conductor 94 to the speakers of the left hand cabinet 24, so that the amplifier 92 powers both speaker assemblies 24 and 26. It will be appreciated that the alternative embodiment of FIG. 3 is somewhat less expensive to manufacture because it includes only a single amplifier for the speaker system 22.

Generally, when one speaks of low frequency speaker systems, they are referring to speaker systems which are capable of generating audible sound waves having frequencies lower than 200 Hz. In the Dolby® 5.1 format, the audio data provided at sixth output 86 has a limited frequency response from 3 Hz to 120 Hz.

Generally speaking, the speaker elements 38 and 40 are selected to be capable of generating sound waves having frequencies lower than 200 Hz. More specifically, they are preferably selected to be capable of efficient generation of sound waves having frequencies lower than 60 Hz, and more specifically in the range of 30 to 60 Hz. These are lower than the frequencies provided by most high fidelity sound sources.

Thus, it is seen that the apparatus of the present invention readily achieves the ends and advantages mentioned, as well as those inherent therein. While certain preferred embodiments of the invention have been illustrated and described for purposes of the present disclosure, numerous changes in the arrangement and construction of parts may be made by those skilled in the art, which changes are encompassed within the scope and spirit of the present invention as defined by the appended claims.

What is claimed is:

1. A low frequency speaker system, comprising:
first and second amplifiers;
an input signal conductor for carrying an input signal of low frequency audio data, and for splitting the input signal and providing the split input signal to both of the first and second amplifiers; and
first and second low frequency speakers for generating sound waves having frequencies lower than 200 Hz, the first and second speakers being connected to the first and second amplifiers, respectively.

2. The system of claim 1, wherein:
the speakers are constructed for generating sound waves having frequencies lower than 60 Hz.

3. The system of claim 1, wherein:
the first and second speakers are separate remote speakers.

4. The system of claim 1, further comprising:
first and second hollow tubular cabinets; and
wherein the first and second speakers are located in the first and second cabinets, respectively.

5. A speaker assembly, comprising:
a cylindrical tubular cabinet having a vertical longitudinal axis and having a cylindrical cabinet cavity;
upper and lower speakers mounted within the cabinet and dividing the cavity into an upper cavity portion above the upper speaker, a middle cavity portion between the speakers, and a lower cavity portion below the lower speaker; and
the upper speaker facing into the upper cavity portion and the lower speaker facing into the lower cavity portion.

6. The assembly of claim 5, wherein:
the cabinet includes a cylindrical wall constructed of high density cardboard.

7. The assembly of claim 6, wherein:
the cylindrical wall includes a wood veneer outer layer.

8. The assembly of claim 6, wherein:
the cabinet further includes an upper end cap and a lower end cap closing the upper and lower ends of the cylindrical wall.

9. The assembly of claim 5, further comprising:
upper, middle and Lower ports defined through the cabinet and communicated with the upper, middle and lower cavity portions, respectively.

10. The assembly of claim 5, wherein:
the upper and lower speakers are circular conical speakers having central axes co-axial with a vertical central axis of the cylindrical cabinet.

11. A speaker system including the speaker assembly of claim 5, and further comprising:
a second such speaker assembly.

12. The speaker system of claim 11, further comprising:
at least one amplifier contained in one of the cabinets.

13. The speaker system of claim 12, further comprising:
an electrical conductor connecting the amplifier to the speakers of the other cabinet so that the one amplifier powers both speaker assemblies.

14. The speaker system of claim 12, further comprising:
a second amplifier contained in the other of the cabinets, each amplifier powering the speakers of its respective cabinet.

15. The speaker system of claim 14, further comprising:
an input signal conductor for carrying an input signal of low frequency audio data, and for splitting the input signal and providing the split input signal to both of the first and second amplifiers.

16. A speaker system, comprising:
first and second vertically oriented cylindrical tubular cabinets; and
first and second low frequency speakers mounted in the first and second cabinets, respectively, for generating sound waves including frequencies lower than 200 Hz; and
first and second table tops mounted on the first and second cabinets, respectively, so that the cabinets provide a pair of end tables.

17. The speaker system of claim 16, wherein:
each of the cylindrical tubular cabinets has an outside diameter of at least twelve inches.

18. The speaker system of claim 17, wherein:
each of the first and second low frequency speakers is a circular conical speaker having a nominal diameter of at least ten inches.

19. The speaker system of claim 16, wherein: each cabinet has a height in the range of from 24 to 36 inches.
